(19) United States
(12) Patent Application Publication
(10) Pub. No.: US 2010/0066933 A1
(43) Pub. Date: Mar. 18, 2010

(54) DISPLAY PLATE AND LIQUID CRYSTAL DISPLAY DEVICE HAVING THE SAME

(75) Inventors: Keun-Chan OH, Cheonan-si (KR); Youn-Hak JEONG, Cheonan-si (KR); Yeon-Sik HAM, Suwon-si (KR); Dong-Gi SEONG, Seongnam-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/543,791

(22) Filed: Aug. 19, 2009

(30) Foreign Application Priority Data
Sep. 17, 2008 (KR) 2008-0090894

(51) Int. Cl. G02F 1/1343; G02F 1/1335; G02F 1/13

(52) U.S. Cl. 349/38; 349/141; 349/106; 349/187

(57) ABSTRACT

A liquid crystal display device includes; a first display panel including; a first substrate, a plurality of gate lines extended substantially parallel to one another in a first direction on the first substrate; a plurality of data lines disposed substantially perpendicular to the gate lines, the data lines including at least one bent portion, a plurality of switching elements including a source electrode extended from the data lines and a drain electrode spaced apart from the source electrode, a plurality of pixel electrodes connected to the drain electrodes, each pixel electrode including a plurality of pixel electrode branches extended substantially in parallel with the data lines, a plurality of first counter electrode branches alternatingly disposed substantially in parallel with the pixel electrode branches and second counter electrode branches vertically aligned with the data lines, respectively.

This application claims priority to Korean Patent Application No. 2008-90894, filed on Sep. 17, 2008, and all the benefits accruing therefrom under 35 U.S.C. §119, the content of which in its entirety is herein incorporated by reference.

### BACKGROUND OF THE INVENTION

1. Field of the Invention

Exemplary embodiments of the present invention relate to a display panel and a liquid crystal display (“LCD”) device having the display panel. More particularly, exemplary embodiments of the present invention relate to a display panel displaying an image using a horizontal electrical field and an LCD device having the display panel.

2. Description of the Related Art

A liquid crystal display (“LCD”) device is a type of flat panel display device displaying an image using liquid crystal molecules. The typical LCD device is relatively thin and light and has low power consumption compared to other types of display devices, thereby operating using a relatively low driving voltage. Therefore, the LCD device is widely used in various data processing applications. The LCD device includes a display panel including opposing substrates on which an electric field generating electrode such as a pixel electrode, a counter electrode, etc., is formed and a liquid crystal layer interposed between the opposing substrates. A voltage is applied to the electric field generating electrode to generate an electric field in the liquid crystal layer and an alignment of liquid crystal molecules of the liquid crystal layer is determined by the applied electric field, so that the polarization of incident light is controlled to display an image.

The typical LCD device includes a switching element connected to each pixel electrode of a plurality of pixel electrodes and a plurality of signal wirings which control the switching element to apply a voltage to the individual pixel electrodes. The signal wirings typically include a plurality of gate wirings, a plurality of data wirings, and various other wirings.

In the LCD devices, an in-plane switching (“IPS”) mode of operation has advantages, such as the availability of a wide viewing angle and a fast response time, in comparison with other modes such as a twisted nematic (“TN”) mode of operation, a vertical alignment (“VA”) mode of operation, and various other modes of operation. In an LCD device utilizing the IPS mode of operation (hereinafter “an IPS mode LCD device”), an electric field having a primary component in a horizontal direction is applied to a liquid crystal layer to twist a liquid crystal direction in a plane substantially parallel with an alignment film.

Recently, in order to increase an aperture ratio and transmittance, a transparent electrode is used as a pixel electrode and a counter electrode which generate a horizontal electric field, and a noise electric field generated by a data wiring is shielded, so that an LCD device having a high aperture ratio and high transmittance may be provided.

### BRIEF SUMMARY OF THE INVENTION

Exemplary embodiments of the present invention provide a display panel of an in-plane switching (“IPS”) mode liquid crystal display (“LCD”) which has a high aperture ratio and high transmittance.

Exemplary embodiments of the present invention also provide an LCD device having the above-mentioned display panel.

According to one exemplary embodiment of the present invention, a display plate includes; a first substrate, a plurality of gate lines extended substantially parallel to one another in a first direction on the first substrate, a plurality of data lines disposed substantially perpendicular to the plurality of gate lines, each of the plurality of data lines comprising at lest one bent portion, a plurality of switching elements, each switching element comprising a source electrode extended from one of the plurality of data lines and a drain electrode spaced apart from the source electrode, a plurality of pixel electrodes, each pixel electrode connected to the drain electrode of a respective switching element of the plurality of switching elements, each pixel electrode including a plurality of pixel electrode branches extended substantially in parallel with the plurality of data lines, a plurality of first counter electrode branches alternatingly disposed substantially in parallel with the plurality of pixel electrode branches, and a plurality of second counter electrode branches vertically aligned with the plurality of data lines, respectively.

According to another exemplary embodiment of the present invention, an LCD device includes an exemplary embodiment of a display panel as described above.

In an exemplary embodiment of the present invention, the LCD device may further include a connection pixel electrode which connects the plurality of pixel electrode branches to each other. In one exemplary embodiment, the connection pixel electrode may be disposed adjacent to, and substantially parallel to, at least one of the plurality of gate lines. Moreover, in one exemplary embodiment, the LCD device may further include; a common electrode disposed as a layer substantially a same distance from the first substrate as the plurality of gate lines, the common electrode being vertically aligned with the connection pixel electrode to form a storage capacitor. In one exemplary embodiment, the plurality of second counter electrode branches and the common electrode may be electrically connected to each other through a contact hole.

In an exemplary embodiment of the present invention, the LCD device may further include; a second display panel including; a second substrate disposed substantially opposite to the first substrate, a light-blocking member disposed on the second substrate and vertically aligned with the plurality of data lines and the plurality of gate lines, the light-blocking member may have a width that is smaller than that of an individual second counter electrode branch of the plurality of second counter electrode branches along an area corresponding to the second counter electrode branch. In addition, in one exemplary embodiment, the LCD device may further include a color filter layer disposed on the second substrate and the light-blocking member, and an overcoating layer disposed on the color filter layer. In one exemplary embodiment, the LCD device may further include a liquid crystal layer disposed between the first display panel and the second display panel and having positive dielectric anisotropy.

According to an exemplary embodiment of a display panel and an LCD device having the display panel, a data line delivering a data voltage is shielded using a counter electrode branch of a transparent electrode, so that the width of a light-blocking member is decreased so that a high aperture ratio and high transmittance of the LCD device may be obtained.

### BRIEF DESCRIPTION OF THE DRAWINGS

The above and other aspects, features and advantages of the present invention will become more apparent by describing in detail exemplary embodiments thereof with reference to the accompanying drawings, in which:

FIG. 1 is a top plan view illustrating an exemplary embodiment of a unit pixel of an exemplary embodiment of a liquid crystal display (“LCD”) device employing an in-plane switching (“IPS”) mode of operation according to the present invention;

FIG. 2 is a cross-sectional view taken along line I-I′ of FIG. 1;

FIG. 3 is a top plan view illustrating a comparative embodiment of an LCD device employing an IPS mode of operation; and

FIG. 4 is a cross-sectional view taken along line II-II′ of FIG. 3.

### DETAILED DESCRIPTION OF THE INVENTION

The invention now will be described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. Like reference numerals refer to like elements throughout.

It will be understood that when an element is referred to as being “on,” another element, it can be directly on the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

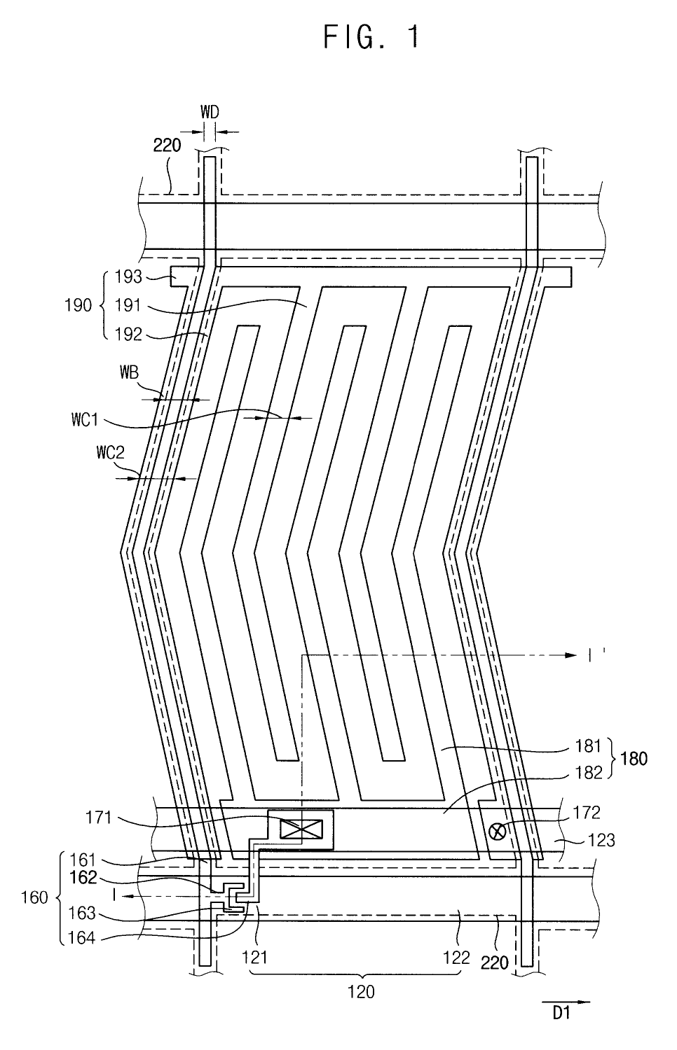

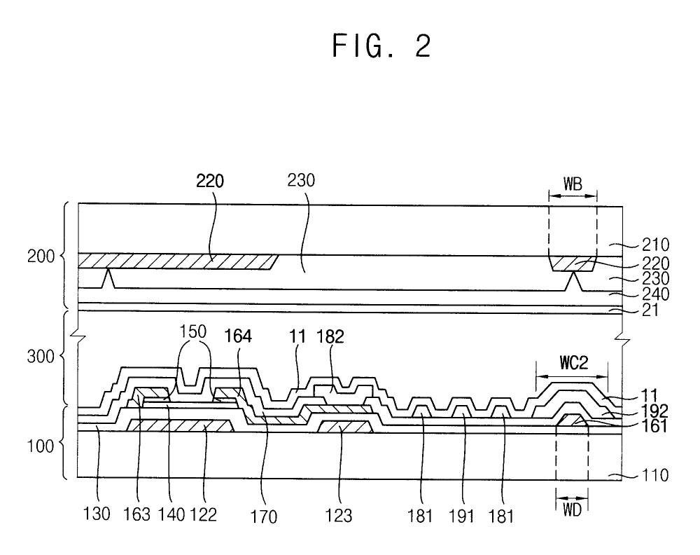

FIG. 1 is a top plan view illustrating an exemplary embodiment of a unit pixel of an exemplary embodiment of a liquid crystal display (“LCD”) device employing an in-plane switching (“IPS”) mode of operation according to the present invention. FIG. 2 is a cross-sectional view taken along line I-I′ of FIG. 1.

Referring to FIGS. 1 and 2, a unit pixel of an exemplary embodiment of an LCD device employing an IPS mode according to the present invention includes a switching element, a common electrode 123, a pixel electrode and a counter electrode. The switching element is connected to a gate wiring 120 and a data wiring 160. The gate wiring 120 is formed on a first substrate 110 and extends in a first direction D1. The data wiring 160 is disposed substantially perpendicular to the gate wiring 120. In the present exemplary embodiment, the gate wirings 120 and the data wirings 160 enclose a pixel area in which the switching element is formed; however, alternative exemplary embodiments include configurations wherein the pixel area may also be otherwise defined.

The gate wiring 120 may include a gate line 121 extended along a first direction, that is, a horizontal direction. A portion of the gate line 121 may define a gate electrode 122 which performs switching of the switching element, e.g., the gate electrode 122 may act as a control terminal of the switching element. Differently from the exemplary embodiment illustrated in FIG. 1, alternative exemplary embodiments may include configurations wherein a gate electrode may be extended from the gate line 121 to have a protrusion shape.

Exemplary embodiments of the gate wiring 120 may include an aluminum (Al)-based metal such as aluminum, an aluminum alloy, or other materials having similar characteristics, a silver (Ag)-based metal such as silver, a silver alloy, or other materials having similar characteristics, a copper (Cu)-based metal such as copper (Cu), a copper alloy, or other materials having similar characteristics, a molybdenum (Mo)-based metal such as molybdenum, a molybdenum alloy, or other materials having similar characteristics, and a metal including chromium (Cr), tantalum (Ta), titanium (Ti), tungsten (W), an alloy thereof, or other materials having similar characteristics. Exemplary embodiments include configurations wherein the gate wiring 120 may have a double-layer structure of metallic materials having different physical characteristics from each other. For example, in one exemplary embodiment the gate wiring 120 includes a first metal layer and a second metal layer that is sequentially formed on the first metal layer. In such an exemplary embodiment, the first metal layer includes an aluminum (Al)-based metal, a silver (Ag)-based metal, a copper (Cu)-based metal, or other materials having similar characteristics. The second metal layer includes a material having excellent physical, chemical and electrical characteristics when contacting indium tin oxide (“ITO”) and/or indium zinc oxide (“IZO”). In one exemplary embodiment, the second metal layer may include, for example, a molybdenum (Mo)-based metal, chromium (Cr), tantalum (Ta), titanium (Ti), tungsten (W), or other materials having similar characteristics. In one exemplary embodiment, the gate wiring 120 may include a lower layer of chromium (Cr) and an upper layer of aluminum (Al) or an aluminum alloy. In another exemplary embodiment, the gate wiring 120 may include a lower layer of aluminum (Al) or aluminum alloy and an upper layer of molybdenum (Mo) or molybdenum alloy. Alternative exemplary embodiments include configurations wherein the gate wiring 120 may be formed from various metals or a conductive substance. Alternative exemplary embodiments also include configurations wherein the gate wiring 120 may include three or more layers. In one exemplary embodiment, a side of the gate wiring 120 is inclined with respect to the first substrate 110. For example, in one exemplary embodiment, an inclination angle may be about 30 degrees to about 80 degrees with respect to the underlying first substrate 110.

A gate insulation layer 130 is formed on the gate wiring 120. Exemplary embodiments of the gate insulation layer 130 may include silicon nitride (SiNx) or silicon oxide (SiOx), although other suitable insulation layers would also be within the scope of these exemplary embodiments.

An island-shape semiconductor layer 140 is formed on the gate insulation layer 130. The island-shape semiconductor layer 140 is positioned on the gate electrode 122, e.g., they are vertically aligned with one another. Exemplary embodiments include configurations wherein the island-shape semiconductor layer 140 may be formed from hydrogenated amorphous silicon (“a-Si:H”), polysilicon, or other materials having similar characteristics.

A couple of ohmic contact members 150 are formed on the island-shape semiconductor layer 140. In one exemplary embodiment, the ohmic contact members 150 may have an island shape. Exemplary embodiments of the ohmic contact members 150 may include silicide or n+ amorphous silicon (“n+ a-Si”) that is formed by implanting silicide or n+ impurities having a high concentration into a non-doped base. Exemplary embodiments include configurations wherein side surfaces of the island-shape semiconductor layer 140 and the ohmic contact member 150 may be also inclined with respect to a surface of the first substrate 110. For example, in one exemplary embodiment, an inclination angle may be about 30 degrees to about 80 degrees with respect to the underlying semiconductor layer 140.

Hereinafter, the data wiring 160 will be described in detail, which is disposed substantially perpendicular to the gate line 121.

According to FIG. 1, the exemplary embodiment of the data wiring 160 according to the present invention includes a data line 161 and a connection data line 162. In the data line 161, a bent portion having a predetermined angle may be formed in correspondence with an intermediate portion of adjacent gate line 121. The connection data line 162 is connected to the data line 161 to be extended in a horizontal direction, substantially parallel to a direction of extension of the gate line 121. In the present exemplary embodiment the data line 161 includes a single bend at a predetermined angle. Alternative exemplary embodiments include configurations wherein the data line 161 may have at least two bent portions in a zigzag shape.

The data wiring 160 may include a refractory metal, exemplary embodiments of which include molybdenum (Mo), chromium (Cr), tantalum (Ta), titanium (Ti), an alloy thereof, or other materials having similar characteristics. The data wiring 160 may include a multilayer structure including the refractory metal (not shown) and a low resistance conductive layer (not shown). An exemplary embodiment of the multilayer structure is a double-layer structure or a triple-layer structure. In an exemplary embodiment of the double-layer structure, chromium (Cr) or a molybdenum (Mo)-based metal is formed, and an aluminum (Al)-based metal is formed on the chromium (Cr) or the molybdenum (Mo)-based metal. In an exemplary embodiment of the triple-layer structure, a molybdenum (Mo)-based metal is formed, an aluminum (Al)-based metal is formed on the molybdenum (Mo)-based metal, and a molybdenum (Mo)-based metal is formed on the aluminum (Al)-based metal. Alternative exemplary embodiments include configurations wherein the data wiring 160 may be formed from various metals or a conductive substance.

Also, exemplary embodiments include configurations wherein a side of the data wiring 160 is inclined with respect to the first substrate 110. For example, in one exemplary embodiment an inclination angle may be about 30 degrees to about 80 degrees with respect to the first substrate 110. In the present exemplary embodiment, the ohmic contact member 150 is only formed between the semiconductor layer 140 and a portion of the data wiring 160 formed on the semiconductor layer 140 to decrease a contact resistance between the semiconductor layer 140 and the associated portion of the data wiring 160. In this exemplary embodiment, an exposed portion may be formed to expose the semiconductor layer 140 in an area between a source electrode 163 and a drain electrode 164 which are described below.

The switching element may include a thin-film transistor (“TFT”) as described in FIG. 1. The switching element includes the gate electrode 122 that is a portion of the gate wiring 120, the semiconductor layer 140 overlapping with the gate electrode 122, the source electrode 163 extended from the connection data line 162, and the drain electrode 164 spaced apart from the source electrode 163 by a predetermined interval distance. The switching element is turned on in accordance with a gate driving signal to perform delivery of an image data voltage delivered through the data line 161 to a pixel electrode through the drain electrode 164.

A protective layer 170 is formed on the data wiring 160 and a portion of the semiconductor layer 140 exposed by the data wiring 160. Exemplary embodiments of the protective layer 170 may include an organic insulation material or an inorganic insulation layer. In an un-shown exemplary embodiment, the protective layer 170 may be planarized. In one exemplary embodiment, the organic insulation material may have a dielectric constant of no more than about 4.0. In one exemplary embodiment, the organic insulation material may have photosensitivity. Exemplary embodiments include configurations wherein the protective layer 170 may have a double-layer structure to maintain superior insulation characteristics of an organic layer and prevent damage to an exposed semiconductor layer 140. A contact hole 171 exposing the drain electrode 164 is formed through the protective layer 170. The contact hole 171 may electrically connect a pixel electrode 180 and the drain electrode 164.

The pixel electrode 180 is formed on the protective layer 170. The pixel electrode 180 may include an optically transparent and electrically conductive material exemplary embodiments of which include ITO, IZO, or other materials with similar characteristics. Alternative exemplary embodiments include configurations wherein the pixel electrode 180 may include a reflective material such as aluminum (Al), silver (Ag), chromium (Cr), an alloy thereof, or other materials with similar characteristics. The pixel electrode 180 receives an image data voltage through the switching element and may include a plurality of pixel electrode branches 181 and a plurality of connection pixel electrodes 182. The pixel electrode branches 181 are formed substantially in parallel with the data line 161 having at least one bent portion. The connection pixel electrode 182 is connected to each of the pixel electrode branches 181 to be disposed substantially in parallel with the gate line 121. The connection pixel electrode 182 may overlap with a common electrode 123 to form a first terminal of a storage capacitor.

The storage capacitor may prevent display defects of an LCD device due to a leakage current which may be generated at the pixel electrode 180. According to an exemplary embodiment of the present invention, the common electrode 123 may form a second terminal of the storage capacitor and may be patterned from a layer substantially identical to the gate wiring 120, e.g., the common electrode 123 and the gate wiring 120 are formed from a common metal layer, and then etched to form the gate wiring 120 and the common electrode 123 so that both the gate wiring 120 and the common electrode 123 are disposed a same distance from the first substrate 110, and may receive a common voltage applied to a counter electrode 190 through a contact hole 172 of the protective layer 170. Moreover, as shown in FIG. 1, in order to make a pixel data voltage more uniform, the common electrode 123 may overlap with, e.g., be vertically aligned with, the connection pixel electrode 182 to fully cover the connection pixel electrode 182.

In a unit pixel area, the common electrode 123 may be formed adjacent to a gate line 121 in order to ensure the maximum aperture ratio of the unit pixel area. Thus, a non-transparent electrode portion used to form a storage capacitor is minimized, so that an aperture ratio may be enhanced. According to an exemplary embodiment of the present invention, each of the connection pixel electrode 182 and the common electrode 123 may have a parallelogram shape in which a first side of a horizontal direction is extended in a long shape as shown in FIG. 1. However, shapes of the connection pixel electrode 182 and the common electrode 123 are not limited to that exemplary embodiment, and may be varied in various shapes so as to ensure an optimized aperture ratio.

Hereinafter, the counter electrode 190 which receives a common voltage for generating a horizontal electric field will be described in detail with reference to FIG. 1.

The counter electrode 190 may include a plurality of first counter electrode branches 191, a second counter electrode branch 192 and a counter electrode line 193. The first counter electrode branches 191 are spaced apart from the pixel electrode branch 181 and are disposed substantially in parallel with the pixel electrode branch 181. The first counter electrode branches 191 are disposed in an alternating arrangement with the pixel electrode branches 181. The second counter electrode branch 192 is formed along the data lines 161 that are disposed to the left and right of a unit pixel when viewed from a top plan view. The counter electrode line 193 is connected to a first terminal of the first counter electrode branches 191 and a first terminal of the second counter electrode branch 192 to be formed in a direction substantially parallel to the gate line 121. The counter electrode 190 is formed as a layer substantially identical to the pixel electrode 180, e.g., in one exemplary embodiment the counter electrode 190 and the pixel electrode 180 are formed by etching or otherwise removing portions of a common metal layer so that the pixel electrode 180 and the counter electrode 190 are both disposed on the same layer above the first substrate 110. The counter electrode 190 may include a transparent electrode that is made from a material substantially identical to the material of the pixel electrode 180. The counter electrode 190 may receive a common voltage through an external pad portion (not shown).

In the present exemplary embodiment, a width WC2 of the second counter electrode branch 192 is greater than a width WC1 of the first counter electrode branch 191. In order to enhance an aperture ratio and the transmittance of an LCD device according to an exemplary embodiment of the present invention, the width WC2 of the second counter electrode branch 192 is greater than a width WD of the data line 161, so that the second counter electrode branch 192 overlaps with the data line 161, e.g., is vertically aligned with the data line 161, to fully cover the data line 161 along a majority of its length as seen from a top plan view. A width WC2 of the second counter electrode branch 192 is greater than a width WD of the data line 161, so that a high aperture ratio may be ensured. An IPS mode of operation of an exemplary embodiment of an LCD device according to the present invention, wherein the LCD device has a high aperture ratio and high transmittance in comparison with a comparative LCD, will be described below.

Next, an exemplary embodiment of an LCD device according to the present invention further includes a second display panel 200 facing the above-described first display panel 100. Hereinafter, the second display panel 200 will be described.

A light-blocking member 220 is formed on a second substrate 210. Exemplary embodiments of the second substrate 210 may include transparent glass, transparent plastic, or other materials with similar characteristics. The light-blocking member 220 may include a boundary portion of the pixel area and a portion corresponding to a TFT. The light-blocking member 220 may prevent light leakage between unit pixels, and may include an opening area wherein the pixel electrode 180 and the counter electrode 190 are exposed therethrough.

In addition, a plurality of color filters 230 may be formed on the second substrate 210 and the light-blocking member 220. The color filter 230 may be mainly formed within an area surrounded by the light-blocking member 220, and in one exemplary embodiment, may be extended along a unit pixel row. Each color filter 230 may display at least one of a primary color such as a red color, a green color and a blue color.

An overcoating layer 240 is formed on the color filter 230 and the light-blocking member 220. Exemplary embodiments of the overcoating layer 240 may include an organic insulation material or an inorganic insulation material. The overcoating layer 240 may prevent exposure of the color filter 230 and may provide a planarization surface. Alternative exemplary embodiments include configurations wherein the overcoating layer 240 may be omitted.

A first alignment layer 11 is formed on a first surface of the first display panel 100, and a second alignment layer 21 is formed on a first surface of the second display panel 200. Here, the first surface of the first display panel 100 faces the first surface of the second display panel 200. In one exemplary embodiment, the first and second alignment layers 11 and 21 may be a horizontal alignment layer, respectively. Moreover, a first polarizing plate (not shown) is disposed on a second surface of the first display panel 100, and a second polarizing plate (not shown) is disposed on a second surface of the second display panel 200. Here, the second surface of the first display panel 100 faces the first surface of the first display panel 100, and the second surface of the second display panel 200 faces the first surface of the second display panel 200, e.g., the first and second surfaces of the first and second display panels 100 and 200 are on opposite sides thereof, respectively.

The exemplary embodiment of an LCD device of the present invention further includes a liquid crystal layer 300 interposed between the first and second display panels 100 and 200. In the present exemplary embodiment, the liquid crystal layer 300 has positive dielectric anisotropy When an electric field is not applied to the pixel electrode 180, long axes of liquid crystal molecules of the liquid crystal layer 300 are aligned in a horizontal direction with respect to surfaces of two display panels 100 and 200. When an image data voltage is applied to the pixel electrode 180, the liquid crystal molecules are rotated and aligned in a vertical direction of the pixel electrode branch 181 at a horizontal surface of the display panels 100 and 200.

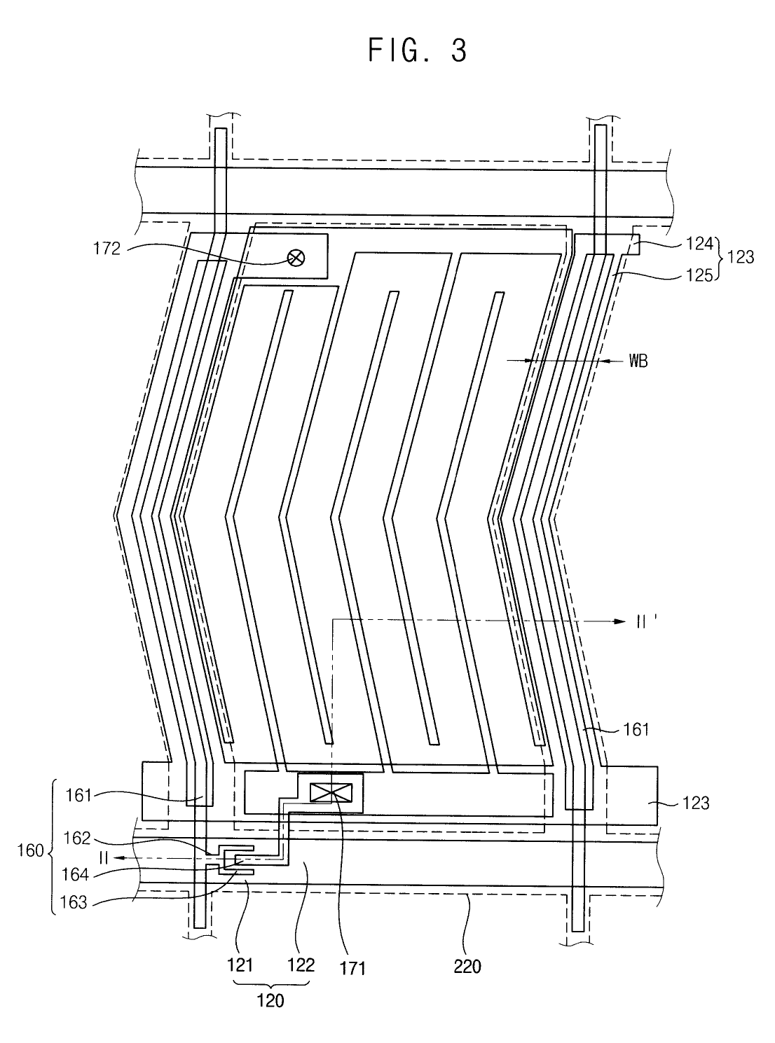

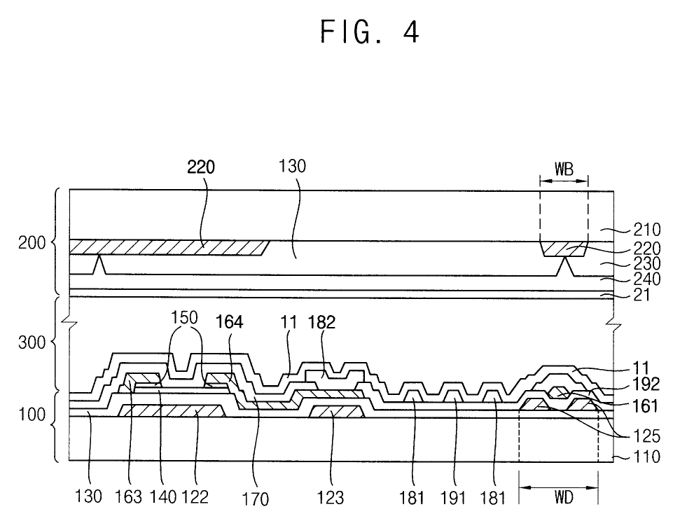

Hereinafter, as described above, an exemplary embodiment of an LCD device utilizing an IPS mode according to the present invention having a high aperture ratio and high transmittance in comparison with a comparative LCD device will be described with reference to FIGS. 3 and 4.

FIG. 3 is a top plan view illustrating an LCD device utilizing an IPS mode according to a comparative embodiment. FIG. 4 is a cross-sectional view taken along line II-II′ of FIG

For convenience of description, elements with respect to FIG. 3 are substantially the same as those described with respect to FIGS. 1 and 2 so that the same reference numerals refer to the same elements and any duplicative illustrations with respect to the elements are omitted herein for brevity.

The LCD device according to a comparative embodiment includes a common electrode 123, a common electrode line 124 and a common electrode branch 125. The common electrode 123 receives a common voltage. The common electrode line 124 is disposed substantially in parallel with a gate line 121 to be respectively formed at an upper portion of a pixel area and a lower portion of the pixel area when viewed from a top plan view. The common electrode branch 125 is disposed to the left and right of a data line 161, which has a bent portion, by a predetermined interval by interposing the data line 161 therebetween, when viewed from a top plan view. The common electrode branch 125 is disposed substantially in parallel with the data line 161. The common electrode 123 is a non-transparent electrode, and the common electrode 123 may be patterned from a layer identical to the gate wiring 120, e.g., they may be formed substantially simultaneously by etching a gate metal layer (not shown). The common electrode branch 123 may prevent light leakage from being generated. When a noise electric field penetrates into a boundary portion of a pixel area, light leakage may be generated. That is, the common electrode branch 125 may shield a noise electric field, so that the alignment uniformity of liquid crystal molecules may be increased within the pixel area.

However, in the comparative embodiment of an LCD device, the common electrode branch 125 that is a non-transparent electrode, being made from the same material as the gate wiring 120, so that loss of an aperture ratio may be generated. In addition, as shown in FIG. 4, in order to prevent a side surface light leakage between a data line 161 and a common electrode branch 125, a width WB of a light-blocking member 220 formed on a second display panel 200 is formed to be wide to fully cover the data line 161 and the common electrode branch 125 formed to the left and right of the data line 161, so that an additional loss of an aperture ratio may be generated.

Referring to FIG. 2, in an exemplary embodiment of an LCD device, in order to shield a noise electric field generated at the data line 161, the second counter electrode branch 192 is formed from a layer used to form a transparent pixel electrode, and therefore the second counter electrode branch 192 is a transparent electrode formed on, e.g., aligned with, the data line 161 to have a width WC2 greater than a width WD of the data line 161, and yet less than a width WB as shown in FIG. 3, so that an aperture ratio may be greatly enhanced as compared with the comparative example. Moreover, due to a shielding effect of the second counter electrode branch 192, a width WD of the light-blocking member 220 formed on the second display plate is formed to substantially fully cover the data line 161, so that the transmittance of the LCD device may be enhanced. While the exemplary embodiment illustrated in FIG. 1 includes a small area of the data line 161 near the gate line 121 which is not covered by the second counter electrode branch 192, this small area is too small to generate electromagnetic noise to effect the display.

An aperture ratio and the transmittance of an LCD device according to a comparative embodiment and an exemplary embodiment of an LCD device according to the present invention will be described with reference to the following Table 1. In order to generate Table 1, the LCD device was designed based on a 4.3-inch quarter video graphics array (“QVGA”) resolution screen.

TABLE 1

| Item | Comparative Embodiment | Exemplary Embodiment |
|---|---|---|
| Resolution | 66 × 198 | 66 × 198 |
| Aperture ratio | 45.5% | 67.6% |
| Transmittance | 4.15% | 6.11% |
| (based on 6 V) | | |

As shown in Table 1, it can be seen that the width of the light-blocking member 220 of an exemplary embodiment is decreased and an aperture ratio of an exemplary embodiment was increased by no less than about 48% in comparison with a comparative embodiment. That is, it can be seen that an aperture ratio according to a comparative embodiment is about 45.5%, and an aperture ratio according to an exemplary embodiment is about 67.6%, so that an aperture ratio of an exemplary embodiment may be increased in comparison with that of a comparative embodiment. Moreover, referring to transmittance, a difference may be generated in accordance with an image data voltage; however, it can be seen that the transmittance of an exemplary embodiment is increased by no less than about 46% in comparison with a comparative embodiment with respect to an application of a reference voltage of about 6 V. That is, it can be seen that the transmittance of a comparative embodiment is about 4.15%, and the transmittance of an exemplary embodiment is about 6.11% when the reference voltage is applied, so that the transmittance of an exemplary embodiment may be increased in comparison with that of a comparative embodiment.

As described above, in an exemplary embodiment of an LCD device employing an IPS mode which displays an image using a horizontal electric field in accordance with the present invention, in order to shield an electric field of a data line delivering an image data voltage, a counter electrode branch is formed on a first display panel to have a larger width than the width of a data line, and the width of a light-blocking member formed on a second display plate is decreased, so that an LCD device of an exemplary embodiment may obtain a high aperture ratio and high transmittance in comparison with a comparative embodiment of an LCD device.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A liquid crystal display device comprising:
a first display panel comprising:
a first substrate;
a plurality of gate lines extended substantially parallel to one another in a first direction on the first substrate;
a plurality of data lines disposed substantially perpendicular to the plurality of gate lines, each of the plurality of data lines comprising at least one bent portion;
a plurality of switching elements, each switching element comprising a source electrode extended from one of the plurality of data lines and a drain electrode spaced apart from the source electrode;
a plurality of pixel electrodes, each pixel electrode connected to the drain electrode of a respective switching element of the plurality of switching elements, each pixel electrode comprising a plurality of pixel electrode branches extended substantially in parallel with the plurality of data lines;
a plurality of first counter electrode branches alternatingly disposed substantially in parallel with the plurality of pixel electrode branches; and
a plurality of second counter electrode branches vertically aligned with the plurality of data lines, respectively.

2. The liquid crystal display device of claim 1, further comprising a connection pixel electrode which connects the plurality of pixel electrode branches to each other.

3. The liquid crystal display device of claim 2, wherein the connection pixel electrode is disposed adjacent to, and substantially parallel to, at least one of the plurality of gate lines.

4. The liquid crystal display device of claim 2, further comprising:
a common electrode disposed as a layer substantially a same distance from the first substrate as the plurality of gate lines, the common electrode being vertically aligned with the connection pixel electrode to form a storage capacitor.

5. The liquid crystal display device of claim 4, wherein the plurality of second counter electrode branches and the common electrode are electrically connected to each other through a contact hole.

6. The liquid crystal display device of claim 1, further comprising:
a counter electrode line connected to the plurality of first counter electrode branches and the plurality of second counter electrode branches.

7. The liquid crystal display device of claim 1, wherein the plurality of pixel electrodes, the plurality of first counter electrodes and the plurality of second counter electrodes are patterned from a same transparent electrode layer.

8. The liquid crystal display device of claim 1, further comprising:
a second display panel comprising:
a second substrate disposed substantially opposite to the first substrate; and
a light-blocking member disposed on the second substrate and vertically aligned with the plurality of data lines and the plurality of gate lines, the light-blocking member having a width that is smaller than that of an individual second counter electrode branch of the plurality of second counter electrode branches along an area corresponding to the second counter electrode branch.

9. The liquid crystal display device of claim 8, further comprising:
a color filter layer disposed on the second substrate and the light-blocking member; and
an overcoating layer disposed on the color filter layer.

10. A display panel comprising:
a substrate;
a plurality of gate lines extended in substantially parallel to one another in a first direction on the substrate;
a plurality of data lines disposed substantially perpendicular to the plurality of gate lines, each of the plurality of data lines comprising at least one bent portion;
a plurality of switching elements, each switching element comprising a source electrode extended from a data line of the plurality of data lines and a drain electrode spaced apart from the source electrode;
a plurality of pixel electrodes, each pixel electrode connected to the drain electrode of a respective switching element of the plurality of switching elements, each pixel electrode comprising a plurality of pixel electrode branches extended substantially in parallel with the plurality of data lines; and
a counter electrode comprising a plurality of first counter electrode branches alternatingly disposed substantially in parallel with the plurality of pixel electrode branches and a second counter electrode branch vertically aligned with at least one data line of the plurality of data lines.

11. A method of manufacturing a liquid crystal display device, the method comprising:
providing a first substrate;
disposing a plurality of gate lines extended substantially parallel to one another in a first direction on the first substrate;
disposing a plurality of data lines substantially perpendicular to the plurality of gate lines, each of the plurality of data lines comprising at least one bent portion;
providing a plurality of switching elements, each switching element comprising a source electrode extended from one of the plurality of data lines and a drain electrode spaced apart from the source electrode;
providing a plurality of pixel electrodes, each pixel electrode connected to the drain electrode of a respective switching element of the plurality of switching elements, each pixel electrode comprising a plurality of pixel electrode branches extended substantially in parallel with the plurality of data lines;
alternatingly disposing a plurality of first counter electrode branches substantially in parallel with the plurality of pixel electrode branches; and
vertically aligning a plurality of second counter electrode branches with the plurality of data lines, respectively.
